(19) United States
(12) Patent Application Publication
(10) Pub. No.: US 2009/0195788 A1
(43) Pub. Date: Aug. 6, 2009

(54) Apparatus for profile irregularity measurement and surface imperfection observation; method of profile irregularity measurement and surface imperfection observation; and inspection method of profile irregularity and surface imperfection

(76) Inventors: Shinichi Dosaka, Sagamihara-shi (JP); Kazuhide Yamazaki, Tokyo-to (JP)

Correspondence Address: KENYON & KENYON LLP, ONE BROADWAY, NEW YORK, NY, 10004, US

(21) Appl. No.: 12/316,839

(22) Filed: Dec. 16, 2008

(30) Foreign Application Priority Data
Dec. 17, 2007 (JP) 2007-325013
Jun. 24, 2008 (JP) 2008-164786

(51) Int. Cl. G01B 11/02

(52) U.S. Cl. 356/511; 356/513

(57) ABSTRACT

An apparatus for performing surface measurement of an inspection-object surface and profile irregularity measurement and surface defect observation of an inspection-object lens using a Fizeau interferometric optical system. The apparatus is provided with a beam control device that has a first beam control plate configured to allow for confirmation of a position of the inspection-object lens in a positional adjustment of the inspection-object lens, a second beam control plate having an aperture region at a center thereof and a shading region around the aperture region, and a third beam control plate having a shading region at a center thereof and an aperture region around the shading region, and that is configured so that a desired one of these beam control plates is insertable and removable on an imaginary plane in which a light convergence point of reflected light from the reference surface of the interferometric optical system lies and which is perpendicular to an optical axis of the interferometric optical system.

This application claims benefits of Japanese Patent Applications No. 2007-325013 filed in Japan on Dec. 17, 2007 and No. 2008-164786 filed in Japan on Jun. 24, 2008, the contents of which are hereby incorporated by reference.

### BACKGROUND OF THE INVENTION

1) Field of the Invention

The present invention relates to an apparatus for profile irregularity measurement and surface imperfection observation and a method of profile irregularity measurement and surface imperfection observation in which a Fizeau interferometric optical system is used. To be specific, it relates to an apparatus for profile irregularity measurement and surface imperfection observation, a method of profile irregularity measurement and surface imperfection observation, and an inspection method of profile irregularity and surface imperfection, which are designed for the purpose of measuring profile irregularity and observing surface imperfection of nearly hemispherical lenses with minute diameters.

2) Description of Related Art

A high profile regularity is required for a nearly hemispherical lens with a minute diameter such as a front-end lens of a microscope objective. In this regard, it is conventionally known to use a Fizeau interferometer for profile irregularity measurement of an inspection object. The Fizeau interferometer is an optical instrument in which light from a light source is made incident on a reference surface, perpendicularly thereto, of a reference lens and then light transmitted through the reference surface, perpendicularly thereto, of the reference lens is made incident on an inspection-object surface, perpendicularly thereto, of an inspection object to make light reflected from the reference surface of the reference lens and light reflected from the inspection-object surface of the inspection object interfere, so that it is capable of measuring the profile irregularity by measuring these interference fringes. As an apparatus using a Fizeau interferometer, there is an apparatus recited in Japanese Patent Kokai No. 2004-226112, for example.

As an apparatus using a Twyman-Green interferometer, there is an apparatus recited in Japanese Patent Kokai No. Hei 10-122833.

### SUMMARY OF THE INVENTION

An apparatus for profile irregularity measurement and surface imperfection observation according to the present invention is an apparatus for performing profile irregularity measurement and surface imperfection observation of an inspection-object surface of an inspection-object lens using a Fizeau interferometric optical system, and includes a beam control device that has a first beam control plate configured to be capable of confirming a position of the inspection-object lens in positional adjustment of the inspection-object lens, a second beam control plate having an aperture region at a center thereof and a shading region around the aperture region, and a third beam control plate having a shading region at a center thereof and an aperture region around the shading region, wherein the beam control device is configured so that a desired one of these beam control plates is insertable and removable on an imaginary plane in which a light convergence point of reflected light from the reference surface of the interferometric optical system lies and which is perpendicular to an optical axis of the interferometric optical system.

Also, it is preferred that the apparatus for profile irregularity measurement and surface imperfection observation according to the present invention has a positional adjustment device that can move the inspection-object lens in a predetermined direction in reference to the optical axis of the interferometric optical system, as a commercially available Fizeau interferometer does.

Also, it is preferred that the apparatus for profile irregularity measurement and surface imperfection observation according to the present invention includes: an imaging optical system that forms an image, at a predetermined image position, of an image of the inspection object formed in the vicinity of the light convergence point; and an optical system having the same image position as the imaging optical system for observation of an image of the first beam control plate disposed on the imaginary plane in which the light convergence point lies and which is perpendicular to the optical axis of the interferometric optical system; wherein each of them is insertable and removable in and out of the light path of the interferometric optical system, as well as that the apparatus includes an image capture device arranged at the image position.

Also, a method of profile irregularity measurement and surface imperfection observation according to the present invention is a method of performing profile irregularity measurement and surface imperfection observation of an inspection-object surface of an inspection-object lens using a Fizeau interferometric optical system, and includes a first process of setting a first beam control plate configured to be capable of confirming a position of the inspection-object lens on an imaginary plane in which a light convergence point of reflected light from a reference surface of the interferometric optical system lies and which is perpendicular to an optical axis of the interferometric optical system while adjusting a position of the inspection-object lens so that light emergent from the reference surface of the interferometric optical system is incident on a surface of the inspection-object lens perpendicular thereto; a second process of performing interference fringe observation upon exchanging the first beam control plate for a second beam control plate having an aperture region at a center thereof and a shading region around the aperture region after the first process; a third process of performing dark field observation upon exchanging the second beam control plate for a third beam control plate having a shading region at a center thereof and an aperture region around the shading region after the second process; and a fourth process of performing bright field observation upon decentering the inspection-object lens after the third process.

Also, in the method of profile irregularity measurement and surface imperfection observation according to the present invention, it is preferable that the third beam control plate includes a plurality of interchangeable beam control plates having annular aperture regions with different diameters around the center regions thereof.

Also, an inspection method of profile irregularity and surface imperfection according to the present invention is an inspection method of profile irregularity and surface imperfection of an inspection-object surface of an inspection-object lens using a Fizeau interferometer, and includes: a process of inspecting profile irregularity of the inspection-object surface using interference fringes that are generated by superposition of reference light reflected from a reference surface and measurement light transmitted through the reference surface and reflected from the inspection-object surface, upon adjusting positions of the reference surface and the inspection-object surface; and a process of inspecting surface imperfection of the inspection-object surface using the measurement light transmitted through the reference surface and reflected from the inspection-object surface upon adjusting the positions of the reference surface and the inspection-object surface to remove the reference light reflected from the reference surface.

The present invention can provide an apparatus for profile irregularity measurement and surface imperfection observation, a method of profile irregularity measurement and surface imperfection observation, and an inspection method of profile irregularity and surface imperfection, which are capable of performing, highly accurately, profile irregularity measurement and lens surface imperfection observation of a nearly hemispherical lens of a minute diameter, using a device applying a Fizeau interferometer. The present invention is useful in fields where a highly accurate inspection of hemispherical lenses with minute diameters such as a front-end lens of a microscope objective is required as to whether imperfection exists.

These and other features and advantages of the present invention will become apparent from the following detailed description of the preferred embodiments when taken in conjunction with the accompanying drawings.

### BRIEF DESCRIPTION OF THE DRAWINGS

FIG. 1. is an explanatory diagram that shows, along an optical axis, the basic configuration of an apparatus for profile irregularity measurement and surface imperfection observation according to one mode of embodiment of the present invention.

FIGS. 2A, 2B and 2C are explanatory diagrams that show the configuration of beam control plates included in a beam control device of the apparatus for profile irregularity measurement and surface imperfection observation of FIG. 1, as being a plan view of a positional adjustment plate as a first beam control plate, a plan view of an interference fringe observation plate as a second beam control plate, and a plan view of a dark-field observation plate as a third beam control plate, respectively.

FIG. 3. is an explanatory diagram that shows the configuration in a state of adjusting a position of an inspection-object lens in the apparatus for profile irregularity measurement and surface imperfection observation of FIG. 1.

FIG. 4. is an explanatory diagram that shows one example of light incidence condition of reflected light from the inspection-object lens on the first beam control plate in terms of a pattern on the first beam control plate, at the initial stage of the positional adjustment of the inspection-object lens using the configuration of FIG. 3.

FIG. 5. is an explanatory diagram that shows the configuration in a state of measuring interference fringes generated by interference of reflected light from the inspection-object surface of the inspection-object lens and reflected light from a reference surface of a reference lens in the apparatus for profile irregularity measurement and surface imperfection observation of FIG. 1.

FIGS. 6A and 6B are explanatory diagrams that show conditions of interference fringes obtained in the configuration of FIG. 5 as pictures: as being a diagram showing the condition of interference fringes in terms of a picture obtained when the beam control plate and an image capture optical system are switched into the interference-fringe observation plate and an interference-fringe observation optical system shown in FIG. 5 after a position of the inspection-object lens is adjusted in the configuration of FIG. 3; and a diagram showing the condition of interference fringes in a linear pattern in terms of a picture obtained when the inspection-object lens is slightly decentered after the inspection-object lens in the condition of FIG. 6A is moved in the direction of the optical axis to cause the interference fringes to vanish (so-called null condition), respectively.

FIGS. 7A, 7B, 7C and 7D are pictures obtained when a surface of an inspection-object lens having defects is observed using the apparatus for profile irregularity measurement and surface imperfection observation of the present invention, as being photographs showing an interference-fringe observation image of the inspection-object surface having defects, a dark-field observation image of the inspection-object surface, a bright-field observation image of the inspection-object surface, and a pseudo bright-field observation image created by image-processing the dark-field image shown in the aforementioned dark-field observation image to invert black and white, respectively.

FIG. 8 is an explanatory diagram that shows the condition where the dark-field observation state is changed to the bright-field observation state in the configuration shown in FIG. 5.

FIG. 9 is a diagram that shows the condition of a beam of rays on the dark-field observation plate in the bright-field observation state shown in FIG. 8.

FIG. 10 is an explanatory diagram that shows the configuration of a dark-field observation plate having an annular aperture region around a shading region at the center, as one modification example of the third beam control plate.

### DETAILED DESCRIPTION OF THE PREFERRED EMBODIMENTS

A mode of embodiment of the present invention is explained in detail in reference to the drawings.

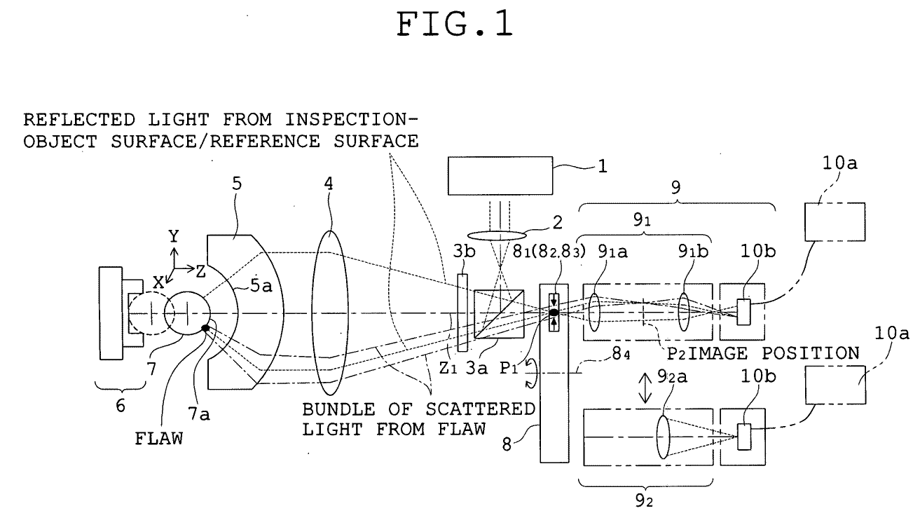

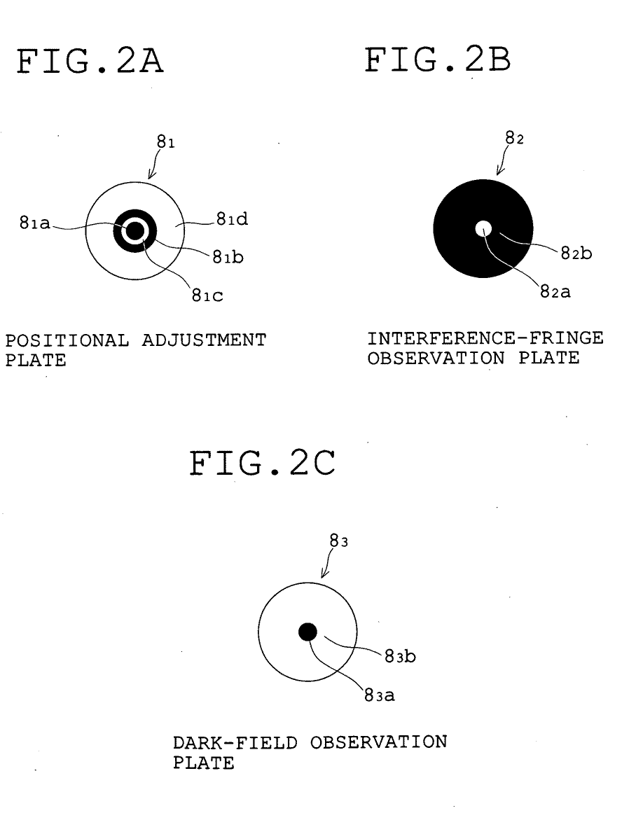

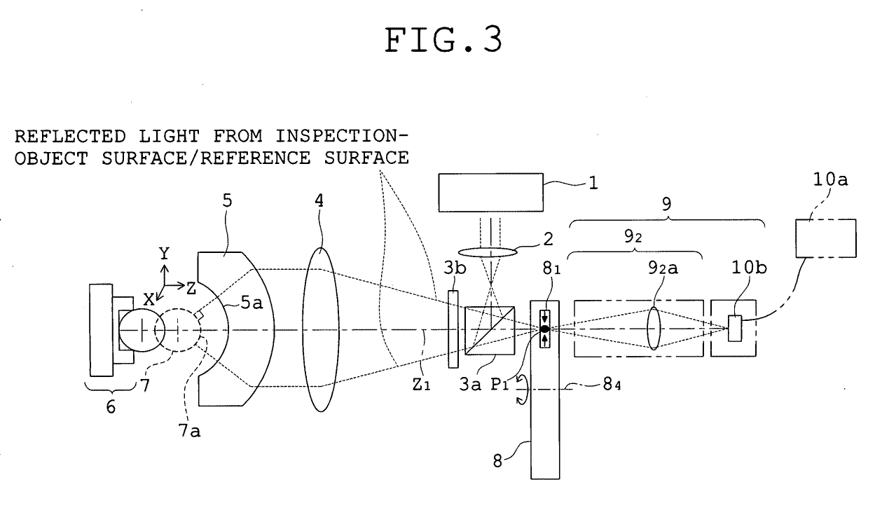

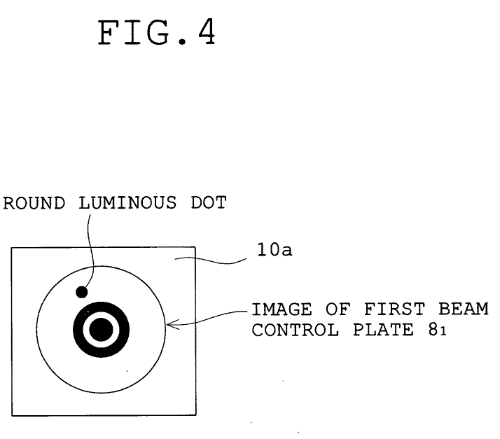

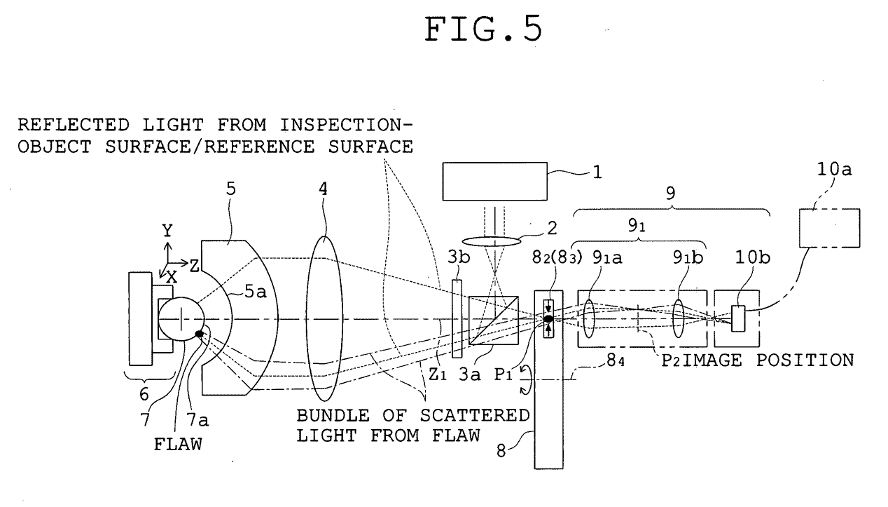

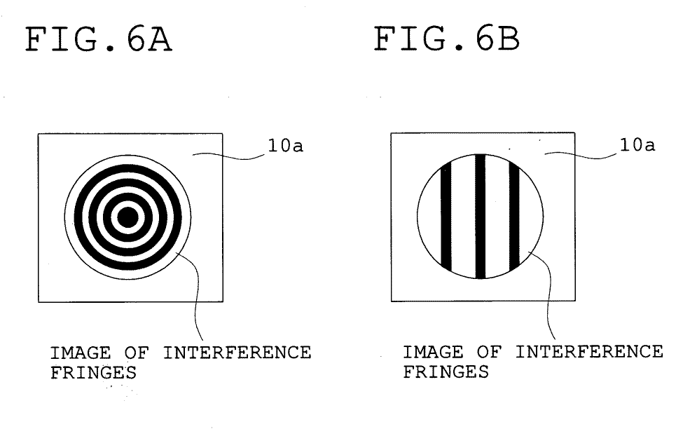

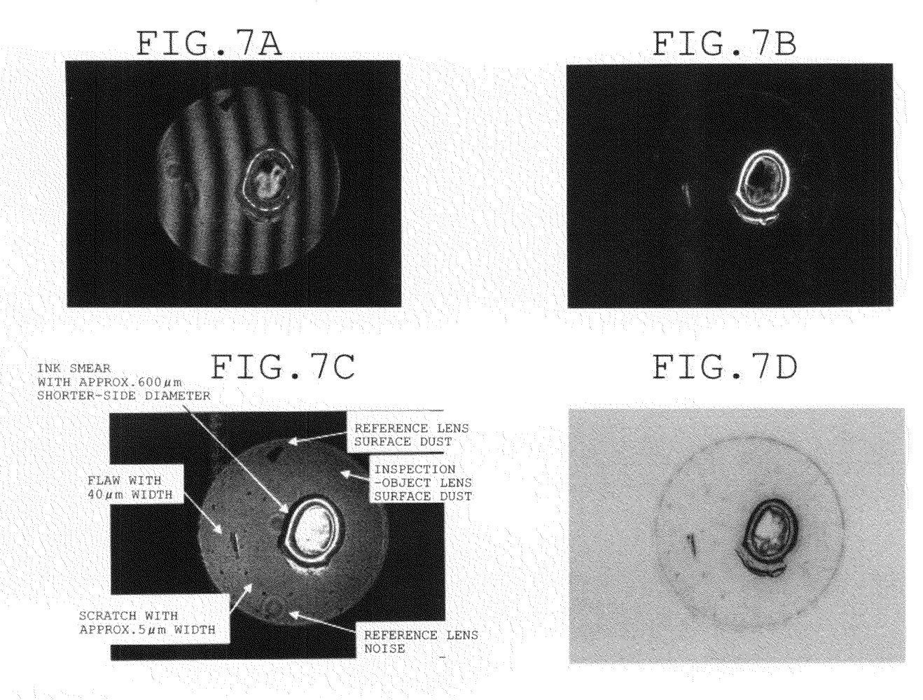

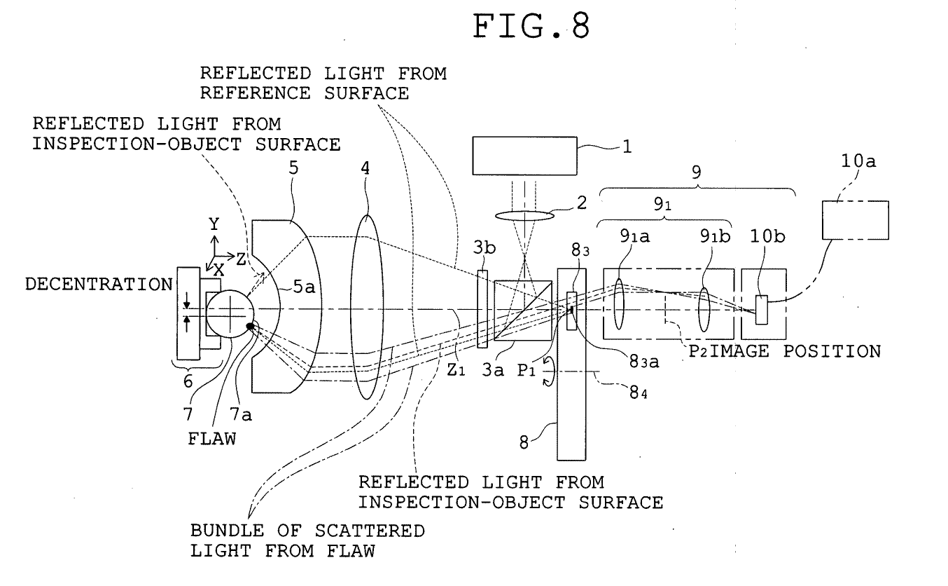

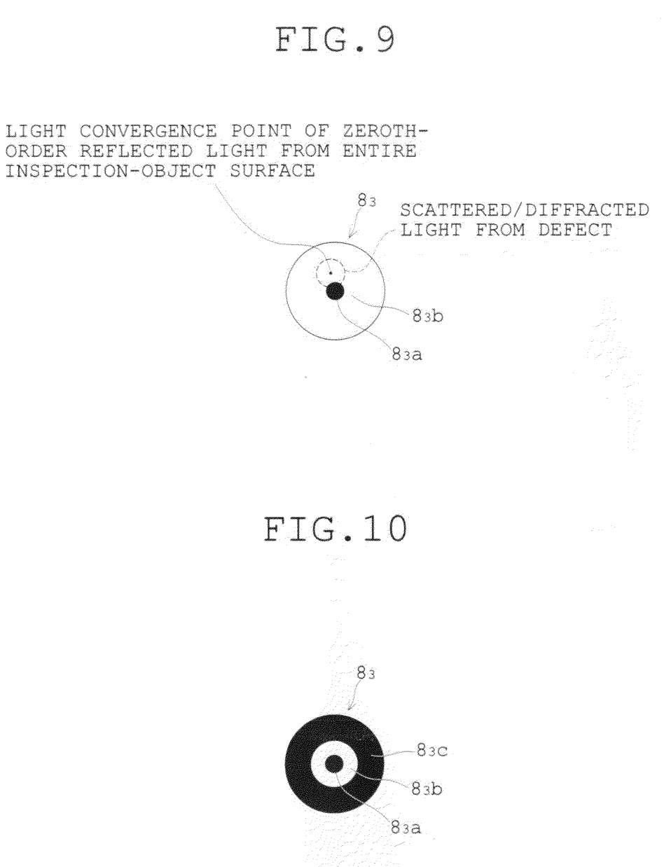

FIG. 1. is an explanatory diagram that shows, along an optical axis, the basic configuration of an apparatus for profile irregularity measurement and surface imperfection observation according to one mode of embodiment of the present invention. FIGS. 2A, 2B and 2C are explanatory diagrams that show the configuration of beam control plates included in a beam control device of the apparatus for profile irregularity measurement and surface imperfection observation of FIG. 1, as being a plan view of a positional adjustment plate as a first beam control plate, a plan view of an interference fringe observation plate as a second beam control plate, and a plan view of a dark-field observation plate as a third beam control plate, respectively. FIG. 3. is an explanatory diagram that shows the configuration in a state of adjusting a position of an inspection-object lens in the apparatus for profile irregularity measurement and surface imperfection observation of FIG. 1. FIG. 4. is an explanatory diagram that shows one example of light incidence condition of reflected light from the inspection-object lens on the first beam control plate in terms of a pattern on the first beam control plate, at the initial stage of the positional adjustment of the inspection-object lens using the configuration of FIG. 3. FIG. 5. is an explanatory diagram that shows the configuration in a state of measuring interference fringes generated by interference of reflected light from the inspection-object surface of the inspection-object lens and reflected light from a reference surface of a reference lens in the apparatus for profile irregularity measurement and surface imperfection observation of FIG. 1. FIGS. 6A and 6B are explanatory diagrams that show conditions of interference fringes obtained in the configuration of FIG. 5 as pictures: as being a diagram showing the condition of interference fringes in terms of a picture obtained when the beam control plate and an image capture optical system are switched into the interference-fringe observation plate and an interference-fringe observation optical system shown in FIG. 5 after a position of the inspection-object lens is adjusted in the configuration of FIG. 3; and a diagram showing the condition of interference fringes in a linear pattern in terms of a picture obtained when the inspection-object lens is slightly decentered after the inspection-object lens in the condition of FIG. 6A is moved in the direction of the optical axis to cause the interference fringes to vanish (so-called null condition), respectively. FIGS. 7A, 7B, 7C and 7D are pictures obtained when a surface of an inspection-object lens having defects is observed using the apparatus for profile irregularity measurement and surface imperfection observation of the present invention, as being photographs showing an interference-fringe observation image, a dark-field observation image, a bright-field observation image, and a pseudo bright-field observation image created by image-processing the dark-field image shown in FIG. 7B to invert black and white, of the inspection-object surface having defects, respectively. FIG. 8 is an explanatory diagram that shows the condition where the dark-field observation state is changed to the bright-field observation state in the configuration shown in FIG. 5. FIG. 9 is an explanatory diagram that shows the condition of a beam of rays on the dark-field observation plate in the bright-field observation state. FIG. 10 is an explanatory diagram that shows one example in which a dark-field observation plate has a ring-shaped aperture region around a shading region at the center. In the drawings, a nearly hemispherical lens is substituted by a ball lens for better legibility of the curvature center of the lens.

The apparatus for profile irregularity measurement and surface imperfection observation of the first mode of embodiment is configured upon using a Fizeau interferometric optical system. To be specific, the Fizeau interferometric optical system of the first mode of embodiment has a laser light source section 1 with an internal structure including a laser light source, a collimator lens, a polarizer, etc. but not shown, a light projecting lens 2, a polarization beam splitter 3a, a quarter-wave plate 3b, a collector lens 4, and a reference lens 5.

In profile irregularity measurement and visual inspection of a nearly hemispherical lens, a lens with an F number about 0.6 (a solid angle for observation about 120 degrees) is used as the reference lens 5, for it is necessary to observe an inspection-object surface over a large solid angle. Considering a solid angle to be inspected on a hemispherical lens is 180 degrees, it is desirable if the solid angle of 180 degrees were assured on the reference lens 5 also. However, the design requirement limits it to about 120 degrees. The focal length of the collector lens 4 is designed to be 10 times that of the reference lens 5.

In front of the reference lens 5 (the left side on the drawing sheet), an X-Y-Z stage 6 as a positional adjustment device is provided. The X-Y-Z stage 6 is configured to be capable of shifting in directions perpendicular to an optical axis Z₁ of the interferometric optical system (X direction and Y direction) and a direction along the optical axis Z₁ (z direction) while holding an inspection-object lens 7. Behind the polarization beam splitter 3a, a beam control device 8 and an image capture optical system 9 are arranged.

The beam control device 8 is constructed of a rotary turret that is provided with beam control plates 8₁-8₃ shown in FIGS. 2A-2C and rotatable on a rotation axis 8₄. The configuration is made so that a desired beam control plate is insertable and removable on an imaginary plane in which a light convergence point P₁ of reflected light from a reference surface of the interferometric optical system lies and which is perpendicular to the optical axis Z₁ of the interferometric optical system by rotating the turret on the rotation axis 8₄. In this mode of embodiment, the reference surface of the interferometric optical system is an object-side surface 5a of the reference lens 5. In addition, the imaginary plane is a plane perpendicular to the drawing sheet of FIG. 1 and not shown. Hereafter, the position of the imaginary plane is referred to as “light convergence position”.

The first beam control plate 8₁ is a beam control plate to be used for confirmation of a position of the inspection-object lens 7 in a positional adjustment of the inspection-object lens 7. As shown in FIG. 2A, it has, at a central region thereof and a predetermined concentric region thereof, a round shading region 8₁a about φ0.5 mm and an annular shading region 8₁b about between φ1 mm and φ2 mm. The rear side of the plate is formed as a frost surface to scatter light. The annular shading region 8₁b is provided as an index, to improve legibility of a positional change of reflected light from a surface 7a of the inspection-object lens incident on the first beam control plate 8₁ as being convergent to have a dot or round shape, and thus may be a reticle instead. In addition, this region is not limited to have a concentric shape.

The second beam control plate 8₂ is a beam control plate used for observation of interference fringes caused by interference of the reflected light from the inspection-object surface of the inspection object lens 7 and reflected light from the reference surface 5a of the reference lens 5. As shown in FIG. 2B, it has an aperture region 8₂a about φ1 mm at a central region thereof and a shading region 8₂b around the aperture region 8₂a. The third beam control plate 8₃ is a beam control plate used for observation of defects on the inspection-object surface of the inspection object lens 7. As shown in FIG. 2C, it has a shading region 8₃a about φ0.25 mm at a central region thereof and an aperture region 8₃b around the shading region 8₃a.

The image capture optical system 9 includes an optical system 9₁ for interference fringe observation and an optical system 9₂ (hereafter referred to as an adjustment optical system) for adjustment of a position of the inspection-object lens, which are interchangeable, and an image capture device 10b. The optical system 9₁ for interference fringe observation is composed of a relay lens 9₁a and an imaging lens 9₁b. The relay lens 9₁a is configured to form a primary image of the inspection-object surface of the inspection-object lens 7 while moving along the optical axis, to make a secondary image of the inspection-object lens formed on the image capture device 10b. The adjustment optical system 9₂ is composed of an imaging lens 9₂a. The imaging lens 9₂a is configured to form, on an image capture surface of the image capture device 10b, an image of the first beam control plate 8₁ inserted in the light convergence position.

Either one of the optical system 9₁ for interference fringe observation and the adjustment optical system 9₂ is inserted in the path of rays behind the beam control device 9 in accordance with the purpose. That is, for positional adjustment of the inspection-object lens 7, the adjustment optical system 9₂ is inserted in the path of rays behind the beam control device 8, while for interference fringe measurement and imperfection observation, the optical system 9₁ for interference fringe observation is inserted in the path of rays behind the beam control device 8. The image capture device 10b is connected with an image display unit 10a.

In the apparatus for profile irregularity measurement and surface imperfection observation according to this mode of embodiment, light that is from the laser light source section 1 and is determined to be S-polarized light in reference to the beam splitter 3a passes through the light projecting lens 2 and is incident on the polarization beam splitter 3a. The incident polarized light is reflected at the polarization beam splitter 3a, passes through the quarter-wave plate 3b and the imaging lens 4, to be incident on the reference lens 5. Of the light incident on the reference lens 5, a part of the light is reflected at the reference surface 5a, and the remaining of the light passes through the reference surface 5a, to be incident on the inspection-object lens 7. Light reflected at the inspection-object lens 7 and the light reflected at the reference surface 5a of the reference lens 5 follow the path of rays backward, to be incident on the polarization beam splitter 3a with the polarization direction being turned by 90 degrees as a result of their passing through the quarter-wave plate twice in the back-and-forth traveling. The incident light passes through the polarization beam splitter 3a, to be incident on the beam control device 8. Light passing through the beam control device 8 is captured by the image capture device 10b via the image capture optical system 9, and the captured image is displayed on a display surface of the image display unit 10a.

Next, the description is made on a method of operating the apparatus for profile irregularity measurement and surface imperfection observation according to this mode of embodiment thus configured.

### (Alignment)

Preceding a measurement of interference fringes, a positional adjustment of the inspection-object lens 7 in reference to the interferometric optical system is conducted. In the positional adjustment, the inspection-object lens 7 is mounted on the X-Y-Z stage 6. In addition, as shown in FIG. 3, the first beam control plate 8₁ is set at the light convergence position and the adjustment optical system 9₂ is set in the path of rays behind the first beam control plate 8₁.

First, the position of the inspection-object lens 7 in X-Y-directions (that is, the directions perpendicular to the optical axis Z₁ of the interferometric optical system) is adjusted in the following manner. The adjustment is made visually so that light from the interferometric optical system converges to form a dot on an extremum point on the surface 7a (substantially at the center of the inspection-object surface) of the inspection-object lens 7, in other words, the highest point, if a convex surface, along the optical axis of the interferometer or the lowest point, if a concave surface, along the optical axis. At this stage, the extremum point on the surface 7a of the inspection-object lens 7 is somewhat deviated from the optical axis Z₁ of the interferometric optical system and does not coincide with a light convergence point of light from the reference surface. In this condition, a beam of reflected rays from the surface 7a of the inspection-object lens 7 is incident on the frost surface of the first beam control plate 8₁ as being convergent to have a round shape and is scattered to form a round bright region. In addition, the reflected light from the reference surface 5a of the reference lens 5 has been adjusted in assembly to converge to have a dot shape on the light convergence point P₁, and thus is interrupted by the shading region 8₁a of the first beam control plate 8₁. The image on the first beam control plate 8₁ in this condition is captured via the adjustment optical system 9₂. Consequently, as shown in FIG. 4, the image on the first beam control plate 8₁ of reflected light from the surface 7a of the inspection-object lens 7 appearing as a round shape is displayed on the display surface of the image display unit 10a.

Then, an adjustment is made using a Z axis of the X-Y-Z stage 6 so that the round bright portion is reduced to a dot. When formed, the luminous dot is made to approach the annular shading region 8₁b by moving along X-Y axes. This operation is repeated until the luminous dot enters the annular shading region 8₁b. In this condition, an image on the first beam control plate 8₁ with the luminous dot disappearing is displayed on the display surface of the image display unit 10a (not shown in the drawing). As stated above, constructing the shading region 8₁b as a ring formed around the central round region (round shading region 8₁a) is for the purpose of improving legibility of movement of the luminous dot.

Then, the position of the inspection-object lens 7 in the Z direction (i.e. the direction along the optical axis Z₁ of the interferometric optical system) is adjusted in the following manner, to be a position where profile irregularity is measurable. The inspection-object lens 7 is shifted via the Z-Y-Z stage 6 in the Z direction by a half the radius of curvature thereof toward the reference lens 5. That is, the adjustment is made so that a light convergence point of light from the reference surface 5a and the center of curvature of the inspection-object surface coincide. In this condition, similar to the pattern shown in FIG. 4, an image on the first beam control plate 8₁ of reflected light from the surface 7a of the inspection-object lens 7 appearing as a round luminous portion is displayed on the display surface of the image display unit 10a. Here, as in the positional adjustment of the inspection-object surface described above, adjustment is made with respect to the Z axis to reduce the round bright portion to a dot, while adjustment is made with respect to the X-Y axes to move this luminous dot closer to the center (i.e. the round shading region 8₁a) of the first beam control plate 8₁. Consequently, the reflected light from the inspection-object lens 7 is incident on the annular shading region 8₁b of the beam control plate 8₁ as being convergent to have a dot shape and is interrupted by the annular shading region 8₁b, so that an image on the first beam control plate 8₁ with the luminous dot disappearing is displayed on the display surface of the image display unit 10a.

According to this process, the inspection-object lens 7 is set at a position where light emergent from the reference surface 5a of the reference lens 5 of the interferometric optical system perpendicularly thereto is incident on the surface 7a perpendicularly thereto. The positional adjustment of the inspection-object lens 7 is thus completed. Here, a range on the surface 7a irradiated with a beam of rays from the interferometric optical system is an inspection range of the inspection-object surface.

### (Measurement of Profile Irregularity)

After the positional adjustment of the inspection-object lens 7 is substantially completed, a measurement of interference fringes is conducted. When the inspection-object lens 7 is set at a position where light emergent from the reference surface 5a of the reference lens 5 perpendicularly thereto is incident on the surface 7a perpendicularly thereto, light reflected from the inspection-object surface follows the path of rays in the reverse direction to the light as incident thereto, to interfere with light reflected from the reference surface 5a of the reference lens 5. This light under interference converges on the light convergence point P₁. However, with the configuration of FIG. 3 remaining unchanged, the light under interference would be interrupted by the annular shading region 8₁b of the first beam control plate 8a. In addition, the adjustment optical system 9₂ is configured to capture an image on the first beam control plate 8₁ via the image capture device 10b, but not to capture an image of interference fringes formed at the light convergence point P₁.

Therefore, to capture interference fringes, the beam control plate on the light convergence position is switched to the second beam control plate 8₂ as well as the relay lens 9₁a is moved to bring the inspection-object surface into focus at the image capture surface of the image capture device 10a. In addition, the adjustment optical system 9₂ is exchanged for the optical system 9₁ for interference fringe observation. At this stage, since the positional adjustment is not completely made, numbers of interference fringes in a concentric pattern appear on the display surface of the image display unit 10a as shown in FIG. 6A. Then, the X-Y-Z stage is fine-controlled so that a uniform color is displayed over the entire region (null condition) on the display surface of the image display unit 10a. When the inspection-object lens 7 is slightly decentered from this condition, interference fringes in a linear pattern as shown in FIG. 6B appear. The profile irregularity is measured based on distortion of the stripes.

### (Observation of Surface Imperfection-Dark-Field Observation)

Here, in a case where the surface 7a of the inspection-object lens 7 has a defect such as a flaw, reflected light from the defect turns into scattered light to travel through positions different from those for the reference light, and thus does not interfere with the reference light. Therefore, for example as shown in FIG. 7A, an image of a defect portion on the surface of the inspection-object lens 7 appears on the display surface of the image display unit 10a together with interference fringes appearing as a result of interference of light reflected at a portion outside the flaw with the reference light. However, the image of the defect portion on the surface of the inspection-object lens 7 has a degraded contrast because it is hidden by the interference fringes or affected, at the bright portions in the interference fringes, by reflected light from the reference surface 5a.

Therefore, to observe the image of the defect portion on the surface with a good contrast, a dark-field observation is conducted first. The inspection-object lens 7, as it is in the condition where interference fringes appear in a straight-line pattern caused by the above-described operation, is returned via the X-Y-Z stage 6 to the position immediately before the decentering. At this position, since the reflected light from the reference surface 5a and from the inspection-object surface is in the null condition, an image with uniform brightness over the entire surface without interference fringes is displayed on the display surface of the image display unit 10a. At this position, also, the curvature center of the surface 7a of the inspection-object lens 7 is aligned with the optical axis Z₁ of the interferometric optical system. Consequently, reflected light from a portion with no defects on the surface 7a of the inspection-object lens 7 and the reflected light from the reference surface 5a of the reference lens 5 converge on the light convergence point P₁. Reflected light from the defect portion on the surface 7a of the inspection-object lens 7 is turned into scattered light and diffracted light, to pass through positions off the light convergence point P₁.

Here, in this condition, the beam control plate is switched to the third beam control plate 8₃. Then, zeroth-order reflected light reflected at the portion with no defects on the surface 7a of the inspection-object lens 7 and the reflected light reflected at the reference surface 5a of the reference lens 5 are intercepted by the shading region 8₃a of the third beam control plate 8₃ at the light convergence position. On the other hand, the scattered light and diffracted light reflected at the defect portion on the surface 7a of the inspection-object lens 7 pass through the aperture region 8₃b around the shading region 8₃a of the third beam control plate 8₃, to be captured by the image capture device 10b. As a result, as shown in FIG. 7B, it is possible to observe a dark-field image with a good contrast formed of scattered light and diffracted light from a defect portion on the inspection-object surface. That is, the so-called schlieren observation is available.

### (Observation of Surface Imperfection-Bright-Field Observation)

Furthermore, when the inspection-object lens 7 is decentered from this condition for dark-field image observation, it is possible to observe a bright-field image with good contrast formed of scattered light and diffracted light from the defect portion on the inspection object surface. That is, if the inspection-object lens 7 is decentered via the X-Y-Z state with respect to one of the X-Y axes, zeroth-order reflected light from a portion with no defects on the inspection-object surface is made to pass through positions off the light convergence point P₁ and is captured by the image capture device 10b through the aperture region 8₃b on the periphery without being intercepted by the shading region 8₃a of the third beam control plate 8₃. In addition, since the scattered light and diffracted light reflected at the defect portion on the surface 7a of the inspection-object lens 7 have large bundles of rays, while a part of the light is intercepted by the shading portion 8₃a of the third beam control plate 8₃, a large part of the light passes through the aperture region 8₃b around the shading region 8₃a, to be captured by the image capture device 10b. In contrast, the reflected light reflected at the reference surface 5a of the reference lens 5 is intercepted by the shading portion 8₃a of the third beam control plate 8₃. In this condition, the beam passing through the dark-field observation plate 8₃ has a positional relationship with the dark-field observation plate 8₃ as shown in FIG. 9, for example. As a result, as shown in FIG. 7C, it is possible to observe a bright-field image with good contrast formed of zeroth-order reflected light from the inspection-object surface without reflected light from the reference surface 5a and scattered light and diffracted light from the defect portion on the inspection-object lens.

Also, it is possible to prevent over-decentration of the inspection object surface and to cut undesirable noise light by providing, in addition to the central shading portion 8₃a, an annular shading portion 8₃c concentrically arranged as shown in FIG. 10, to form the aperture region 8₃b to have an annular shape with a predetermined diameter. The diameter of this annular aperture region 8₃b is desirably 2 to 5 mm. It is also preferred that the turret 8 is equipped with a plurality of dark-field observation plates 8₃ having annular apertures with different diameters to be interchangeably used in accordance with application.

In this way, according to the apparatus for profile irregularity measurement and surface imperfection observation of this mode of embodiment, it is possible to measure profile irregularity of an inspection-object lens highly accurately and to observe imperfection of the inspection-object lens highly accurately using the same apparatus. That is, the apparatus has a wide applicability. In addition, according to the apparatus for profile irregularity measurement and surface imperfection observation, the same reference lens or reference lenses with different F numbers are available for different inspection-object lenses, because a Fizeau interferometer is employed.

In the present observation method, pseudo bright-field observation is available upon creating an image with inverted black and white as shown in FIG. 7D by image-processing the dark-field observation image shown in FIG. 7B. However, it should be reminded that the reference lens is primarily designed not for observation of images and that inspection-object lenses with a same solid angle for observation and different radii of curvature have images with a same size as captured by the image capture device. That is, if comparison is made between lenses with radii of curvature of 1 mm and 5 mm, magnification of the image of the lens with the radius 5 mm is ⅕ of that of the lens with the radius 1 mm; resolving power is thus degraded. Therefore, although depending on the inspection accuracy actually required in an inspection operation, a radius of curvature of a lens as an observation object should be determined to be about 1/10 of the reference lens.

In the apparatus for profile irregularity measurement and surface imperfection observation according to this mode of embodiment, the beam control device 8 is constructed of a turret provided with the beam control plates 8₁-8₃. However, the beam control device 8 is not limited to this structure as long as a desired beam control plate is insertable and removable in and out of the light convergence position. For example, the beam control device 8 may be constructed as a slider provided with the beam control plats 8₁-8₃. Alternatively, each beam control plate in the beam control device may be combined with its mate observation optical system in the image capture optical system 9, to form a unit. That is, a unit including the first beam control plate 8₁ and the adjustment optical system 9₂, a unit including the second beam control plate 8₂ and the optical system 9₁ for interference fringe observation, and a unit including the third beam control plate 8₃ and the optical system 9₁ for interference fringe observation are provided, and a desired beam control plate is made insertable and removable in and out of the light convergence position by inserting and removing each of the units in the path of rays of the interferometric optical system.

### Embodiment Example 1

In a Fizeau interferometer manufactured by Olympus Corporation having a configuration similar to that of this mode of embodiment, profile irregularity was measured and surface imperfection were observed with respect to hemispherical lenses with radii of curvature in a range of 11.0 mm to 5.0 mm, using a reference lens with an F number of 0.6 and a focal length of 36 mm as the reference lens 7 and an imaging lens with a focal length of 350 mm as the imaging lens 4. A part of pictures of a sphere segment (with an expanded diameter about φ2 mm) obtained from a hemispherical lens with a radius of curvature of 11.0 mm under the 120-degree observation field are shown in FIGS. 7A-7D. FIG. 7A is an interference-fringe observation image, FIG. 7B is a dark-field observation image of a defect portion, FIG. 7C is a bright-field observation image of the inspection-object surface, and FIG. 7D is a pseudo bright-field observation image created by image-processing the dark-field image shown in FIG. 7B to invert black and white. As a result of the observation, a flaw with a 2 μm width was detected on the hemispherical lens with 1R, and a flaw with a 10 μm width and a stain remaining unwiped were detected on the hemispherical lens with 5R.

### Embodiment Example 2

Next, the inspection method of profile irregularity and surface imperfection according to the present invention is explained using the apparatus for profile irregularity measurement and surface imperfection observation according to this mode of embodiment described above.

The Fizeau interferometer used in this embodiment example has a two-axis tilt adjustment mechanism at the mount portion for the reference lens 5 in the apparatus for profile irregularity measurement and surface imperfection observation according to this mode of embodiment described above. By tilting the reference lens 5 with the two-axis tilt adjustment mechanism upon mounting it on the mount portion, it is possible to switch the reference light to be incident or not incident, that is, to be removed, on the image capture element of the image capture device 10b.

The reference lens 5 is mounted on the reference lens mount portion of the main body of the Fizeau interferometer. In addition, the inspection-object lens 7 is held on the X-Y-Z stage 6 (three-axis shift stage) of the main body of the interferometer. Then, a two-axis tilt adjustment of the reference lens 5 and a three-axis shift adjustment of the inspection-object lens 7 are conducted using the first beam control plate 8₁. Upon completion of the adjustments, the first beam control plate is exchanged for the second beam control plate 8₂, and reference light reflected at the reference surface 5a and measurement light transmitted through the reference surface 5a and reflected at the surface 7a, which is an inspection range on the inspection-object surface of the inspection-object lens 7, are superposed on each other on the image capture element of the image capture device 10b provided inside the main body of the interferometer, to generate interference fringes. Then, the optical system in the main body of the interferometer is adjusted so that the surface 7a, which is the inspection range on the inspection-object surface of the inspection-object lens 7, is in focus. Then, by analyzing interference fringes in this condition, profile irregularity of the inspection-object surface of the inspection-object lens 7 is inspected. This process is basically the same as the “measurement of profile irregularity” described above.

Next, with the second beam control plate 8₂ being selected, tilt of the reference lens 5 is adjusted by the two-axis tilt adjustment mechanism so that the reference light should not be incident on the image capture element of the image capture device 10b. That is, the reference lens 5 is decentered as slightly tilted from the normal position so that the reference light does not pass through the aperture of the second beam control plate 8₂. Since the measurement light also is shifted in this occasion, the shift adjustment of the inspection-object lens 7 should be reconducted after the tilt adjustment of the reference lens 5 so that the reflected light from the inspection-object surface could pass through the second beam control plate 8₂. Whereby, the reference light is made not to be incident on the image capture element of the image capture device 10b at all as being removed, and only the measurement light is incident on the image capture element. In this condition, the surface 7a on the inspection-object surface of the inspection-object lens 7 has already been in focus. By capturing the measurement light, surface imperfection of the inspection-object surface is inspected.

Although the reference lens is decentered from the optical axis of the apparatus together with the reference surface, this process decenters the inspection-object surface in the opposite direction relatively, and thus facilitates highly accurate inspection without degrading the image quality. In addition, since there is no need to arrange an optical element between the reference surface and the inspection-object surface as in the apparatus disclosed by Japanese Patent Kokai No. Hei 10-122833, a large work distance (WC) can be secured.

In this embodiment example, explanation is made on an example where profile irregularity is inspected first and then surface imperfection. However, this order may be reversed. In addition, in the embodiment example previously described, explanation is made on a case where the first to third beam control plates are used. In contrast, according to this embodiment example, the mount portion for reference lens provided with a two-axis tilt adjustment mechanism allows the reference light reflected at the reference surface to be removed by tilting the reference lens. Therefore, inspection of profile irregularity and surface imperfection is available without any modification of an existing Fizeau interferometer.

What is claimed is:

1. An apparatus for profile irregularity measurement and surface imperfection observation of an inspection-object surface of an inspection-object lens, using a Fizeau interferometric optical system, comprising a beam control device,
wherein the beam control device has:
a first beam control plate constructed and arranged to allow for confirmation of a position of the inspection-object lens in a positional adjustment of the inspection-object lens;
a second beam control plate having an aperture region at a center thereof and a shading region around the aperture region; and
a third beam control plate having a shading region at a center thereof and an aperture region around the shading region, and
is constructed and arranged so that a desired one of the beam control plates is insertable and removable on an imaginary plane in which a light convergence point of reflected light from a reference surface of the interferometric optical system lies and which is perpendicular to an optical axis of the interferometric optical system.

2. An apparatus for profile irregularity measurement and surface imperfection observation according to claim 1, wherein the apparatus has a positional adjustment device that can move the inspection-object lens in a predetermined direction in reference to the optical axis of the interferometric optical system.

3. An apparatus for profile irregularity measurement and surface imperfection observation according to claim 1, wherein the apparatus comprises:
an imaging optical system that forms an image, at a predetermined image position, of an image of the inspection object formed in a vicinity of the light convergence point; and
an optical system for observation of an image of the first beam control plate disposed on the imaginary plane in which the light convergence point lies and which is perpendicular to the optical axis of the interferometric optical system, having a same image position as the imaging optical system;
each of the imaging optical system and the optical system for observation of an image of the first beam control plate being insertable and removable in and out of a path of rays of the interferometric optical system, and
wherein the apparatus further comprises an image capture device arranged at the image position.

4. A method of profile irregularity measurement and surface imperfection observation of an inspection-object surface of an inspection-object lens using a Fizeau interferometric optical system, comprising:
a first process of setting a first beam control plate configured to be capable of confirming a position of the inspection-object lens on an imaginary plane in which a light convergence point of reflected light from a reference surface of the interferometric optical system lies and which is perpendicular to an optical axis of the interferometric optical system while adjusting a position of the inspection-object lens so that light emergent from a reference surface of the interferometric optical system is incident on a surface of the inspection-object lens perpendicular thereto;
a second process of performing interference fringe observation upon exchanging the first beam control plate for a second beam control plate having an aperture region at a center thereof and a shading region around the aperture region after the first process;
a third process of performing dark-field observation upon exchanging the second beam control plate for a third beam control plate having a shading region at a center thereof and an aperture region around the shading region after the second process; and
a fourth process of performing bright-field observation upon decentering the inspection-object lens after the third process.

5. A method of profile irregularity measurement and surface imperfection observation according to claim 4, wherein the third beam control plate includes a plurality of interchangeable beam control plates having annular aperture regions with different diameters around the center regions thereof.

6. An inspection method of profile irregularity and surface irregularity of an inspection-object surface of an inspection-object lens using a Fizeau interferometer, comprising:
a process of inspecting profile irregularity of the inspection-objectsurfaceusinginterferencefringesthataregenerated by superposition of reference light reflected from a reference surface and measurement light transmitted through the reference surface and reflected from the inspection-object surface, upon adjusting positions of the reference surface and the inspection-object surface; and
a process of inspecting surface imperfection of the inspection-object surface using the measurement light transmitted through the reference surface and reflected from the inspection-object surface upon adjusting the positions of the reference surface and the inspection-object surface to remove the reference light reflected from the reference surface.
